(19) United States
(12) Patent Application Publication
(10) Pub. No.: US 2022/0069534 A1
(43) Pub. Date: Mar. 3, 2022

(54) TERMINAL CRIMPING DEVICE

(71) Applicant: Yazaki Corporation, Tokyo (JP)

(72) Inventors: Koutatsu SHIBAYAMA, Shizuoka (JP); Shoya UEDA, Shizuoka (JP)

(73) Assignee: Yazaki Corporation, Tokyo (JP)

(21) Appl. No.: 17/464,003

(22) Filed: Sep. 1, 2021

(30) Foreign Application Priority Data
Sep. 3, 2020 (JP) 2020-148189

(51) Int. Cl. H01R 43/058; H01R 43/048

(52) U.S. Cl. CPC H01R 43/058; H01R 43/048

(57) ABSTRACT

A terminal crimping device includes a lower mold and an upper mold. The lower mold has a lower contact face onto which a crimping and forming part is to be mounted, and a lower mold recessed part that is recessed in an opposite direction to a crimping direction and a lower mold projecting part that projects in the crimping direction, respectively from both end parts of the lower contact face in width directions when viewed in front-rear directions. The upper mold has an upper contact face, an upper mold recessed part and an upper mold projecting part.

### CROSS-REFERENCE TO RELATED APPLICATION(S)

The present application claims priority to and incorporates by reference the entire contents of Japanese Patent Application No. 2020-148189 filed in Japan on Sep. 3, 2020.

### BACKGROUND OF THE INVENTION

### 1. Field of the Invention

The present invention relates to a terminal crimping device.

### 2. Description of the Related Art

The terminal crimping device is a device for manufacturing a terminal-attached electric wire having a crimped part. The terminal crimping device includes a lower mold and an upper mold, which are able to come close to and away from each other in upper-lower directions. When the lower mold and the upper mold are in proximity to each other, the terminal crimping device crimps a crimping and forming part of a crimp terminal to a part of an electric wire to form the crimped part on the crimp terminal (for example, see Japanese Patent Application Laid-open No. 2013-30274).

The lower mold of the terminal crimping device described above has a lower contact face onto which a crimping and forming part is to be mounted, and a first recessed part and a second recessed part that are respectively recessed downwardly from both end faces of the lower contact face in width direction.

The upper mold of the terminal crimping device described above has an upper contact face that crimps a crimping and forming part to a part of an electric wire, together with the lower contact face, when the lower mold and the upper mold are in proximity to each other, and a first projecting part and a second projecting part that are respectively projected downwardly from both end parts of the upper contact face in the width directions, and that engage with the first recessed part and the second recessed part.

When the lower mold and the upper mold are in proximity to each other in the terminal crimping device, the lower contact face and the upper contact face both then press a crimping and forming part that is sandwiched between the first projecting part and the second projecting part, allowing the crimping and forming part to plastically deform to form a crimped part. In the terminal crimping device, it is therefore possible, with the first projecting part and the second projecting part, to manufacture a terminal-attached electric wire, while preventing burrs from occurring on a crimped part.

However, in the terminal crimping device described above, the upper contact face and the lower contact face press a crimping and forming part that is sandwiched between the first projecting part and the second projecting part to plastically deform the crimping and forming part. At this time, in the terminal crimping device, a crimped part formed between the first projecting part and the second projecting part gives pressure to the first projecting part and the second projecting part outwardly from the crimped part itself. Even when the upper mold and the lower mold come away from each other, the crimped part mounted on the lower contact face of the lower mold therefore may not come off the upper contact face of the upper mold. In this case, an operator is required to remove the crimp terminal from the upper mold. Therefore, there is a need for improvement in terms of work efficiency.

Furthermore, even if, in such a terminal crimping device as described above, a lower mold is provided with a first projecting part and a second projecting part, and an upper mold is provided with a first recessed part and a second recessed part, similar problems may arise.

### SUMMARY OF THE INVENTION

In view of the issues described above, an object of the present invention is to provide a terminal crimping device allowing a crimp terminal to be easily removed from molds.

In order to achieve the above mentioned object, a terminal crimping device for manufacturing a terminal-attached electric wire having a crimped part, the terminal according to one aspect of the present invention includes a lower mold; and an upper mold, wherein the lower mold and the upper mold are able to come close to and away from each other in upper-lower directions, the terminal crimping device is configured to crimp, when the lower mold and the upper mold are in proximity to each other, a crimping and forming part of a crimp terminal to a part of the electric wire to form the crimped part on the crimp terminal, the lower mold has: a lower contact face onto which at least the crimping and forming part is to be mounted, and a lower mold recessed part that is recessed in an opposite direction to a crimping direction and a lower mold projecting part that projects in the crimping direction, respectively from both end parts of the lower contact face in width directions, the upper mold has: an upper contact face that crimps the crimping and forming part to the part of the electric wire, together with the lower contact face, when the lower mold and the upper mold are in proximity to each other, and an upper mold recessed part that is recessed in the opposite direction to the crimping direction and an upper mold projecting part that projects in the crimping direction, respectively from both end parts of the upper contact face in the width directions, the upper mold recessed part engaging with the lower mold projecting part when the lower mold and the upper mold are in proximity to each other, the upper mold projecting part engaging with the lower mold recessed part when the lower mold and the upper mold are in proximity to each other.

According to another aspect of the present invention, in the terminal crimping device, it is possible to configure that with respect to the lower mold, the upper mold recessed part is positioned adjacent to one of the both end parts of the lower contact face in the width directions, and the upper mold projecting part is positioned adjacent to another one of the both end parts of the lower contact face in the width directions, and, with respect to the upper mold, the lower mold recessed part is positioned adjacent to one of the both end parts of the upper contact face in the width directions, and the lower mold projecting part is positioned adjacent to another one of the both end parts of the upper contact face in the width directions.

According to still another aspect of the present invention, in the terminal crimping device, it is possible to configure that the lower mold has: a lower mold main body part, a lower indent part that projects from the lower mold main body part in the crimping direction, and the lower contact face lying on an upper surface of the lower indent part, a length of the lower mold projecting part in front-rear directions is longer than a length of the lower indent part in the front-rear directions, the upper mold has: an upper mold main body part, an upper indent part that projects from the upper mold main body part in the crimping direction, and the upper contact face lying on a lower surface of the upper indent part, and a length of the upper mold projecting part in the front-rear directions is longer than a length of the upper indent part in the front-rear directions.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal crimping device according to the present embodiment;

FIG. 2 is a perspective view of a lower mold that the terminal crimping device according to the present embodiment includes;

FIG. 3 is a plan view of the lower mold that the terminal crimping device according to the present embodiment includes;

FIG. 4 is a perspective view of an upper mold that the terminal crimping device according to the present embodiment includes;

FIG. 5 is a bottom view of the upper mold that the terminal crimping device according to the present embodiment includes;

FIG. 6 is a cross-sectional view of a state where the upper mold is caused to come away from the lower mold, in the terminal crimping device according to the present embodiment;

FIG. 7 is a cross-sectional view of a state where the upper mold is caused to come away from the lower mold, in the terminal crimping device according to the present embodiment;

FIG. 8 is a cross-sectional view of a state when the lower mold and the upper mold are in proximity to each other in upper-lower directions, in the terminal crimping device according to the present embodiment; and

FIG. 9 is a cross-sectional view of a state after a crimp terminal is crimped to a part of an electric wire, in the terminal crimping device according to the present embodiment.

### DETAILED DESCRIPTION OF THE PREFERRED EMBODIMENTS

A terminal crimping device 2 according to an embodiment of the present invention will now be described in detail with reference to the accompanying drawings. Note that the present embodiment does not intend to limit the present invention.

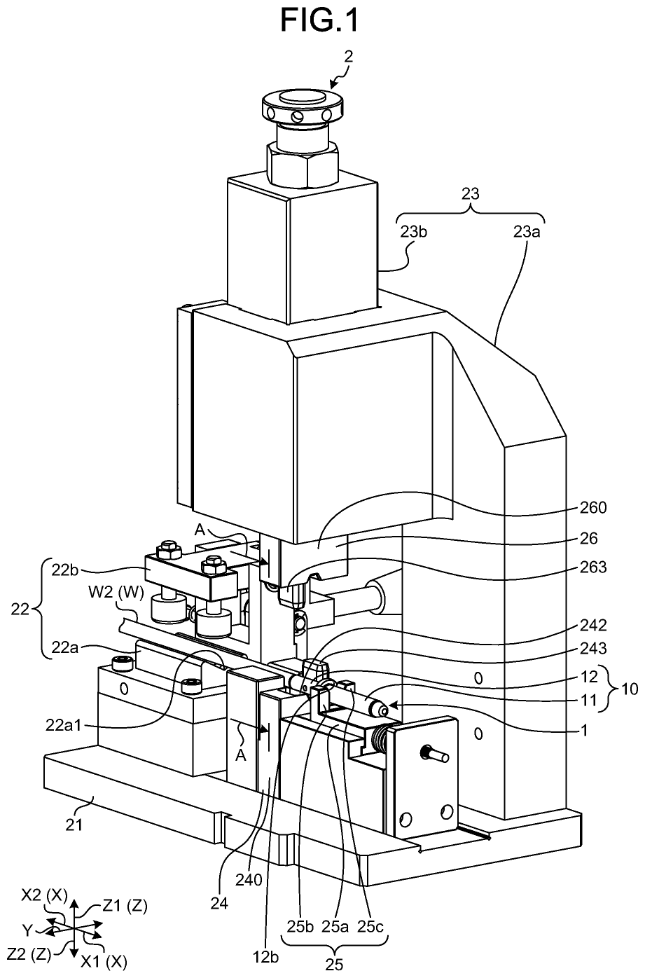

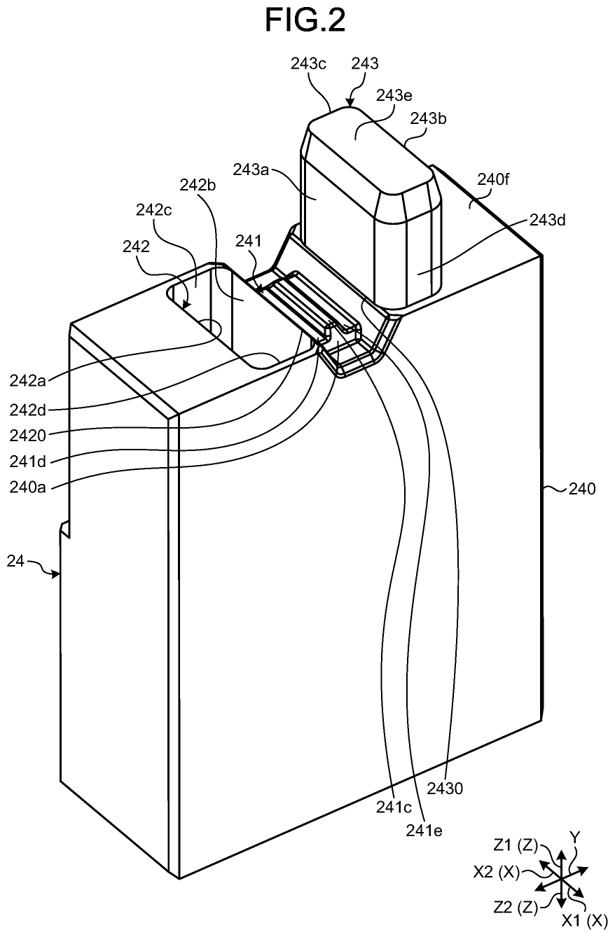

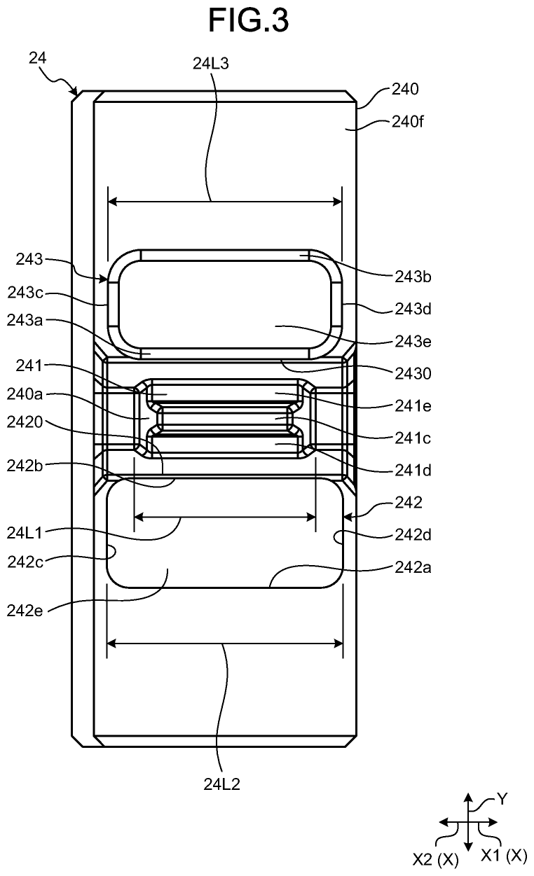

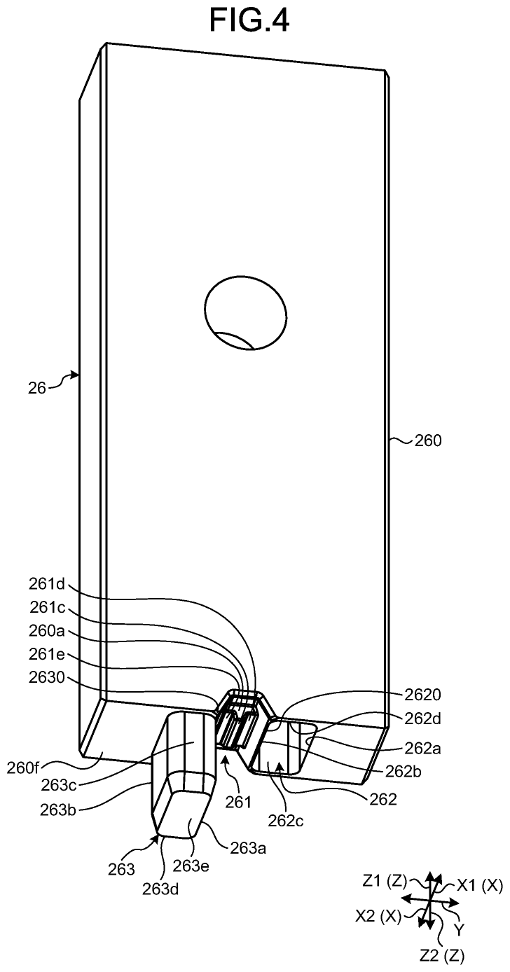

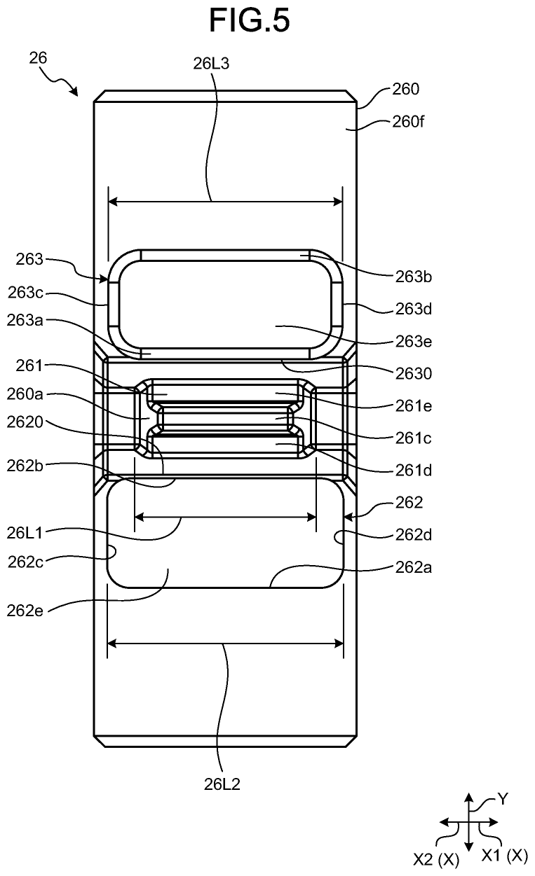

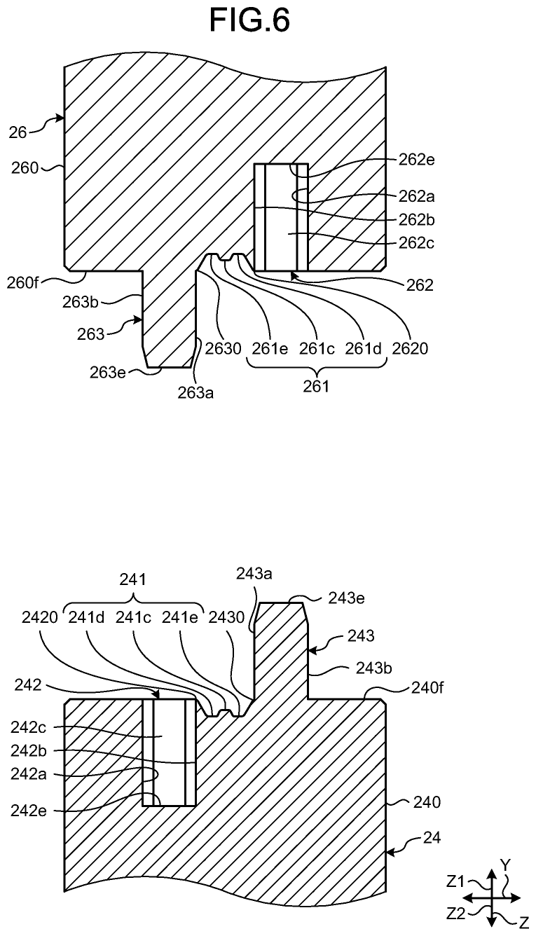

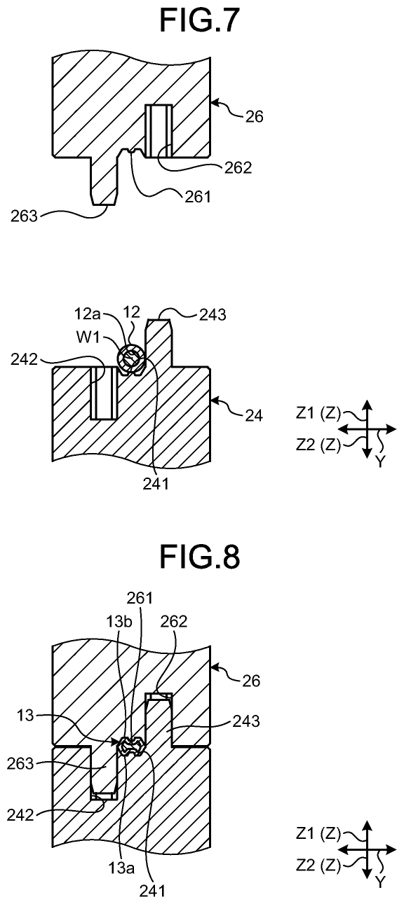

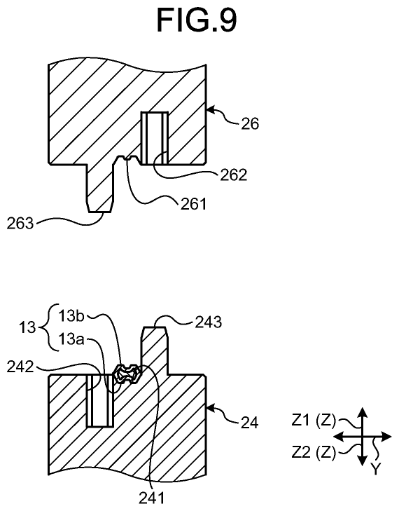

FIG. 1 is a perspective view of the terminal crimping device 2 according to the present embodiment. FIG. 2 is a perspective view of a lower mold 24 that the terminal crimping device 2 according to the present embodiment includes. FIG. 3 is a plan view of the lower mold 24 that the terminal crimping device 2 according to the present embodiment includes. FIG. 4 is a perspective view of an upper mold 26 that the terminal crimping device 2 according to the present embodiment includes. FIG. 5 is a bottom view of the upper mold 26 that the terminal crimping device 2 according to the present embodiment includes. FIG. 6 is a cross-sectional view of a state where the upper mold 26 is caused to come away from the lower mold 24, in the terminal crimping device 2 according to the present embodiment. FIG. 7 is a cross-sectional view of a state where the upper mold 26 is caused to come away from the lower mold 24, in the terminal crimping device 2 according to the present embodiment. FIG. 8 is a cross-sectional view of a state when the lower mold 24 and the upper mold 26 are in proximity to each other in upper-lower directions Z, in the terminal crimping device 2 according to the present embodiment. FIG. 9 is a cross-sectional view of a state after a crimp terminal 10 is crimped to a part of an electric wire W, in the terminal crimping device 2 according to the present embodiment.

In FIGS. 1 to 9, X indicates front-rear directions X of the terminal crimping device 2. X1 indicates a front direction. X2 indicates a rear direction. Y indicates width directions Y of the terminal crimping device 2. Y1 indicates one direction. Y2 indicates another direction. Z indicates the upper-lower directions Z of the terminal crimping device 2. Z1 indicates an upper direction. Z2 indicates a lower direction. In the terminal crimping device 2 according to the present embodiment, the front-rear directions X, the width directions Y, and the front-rear directions X are orthogonal to each other.

### Embodiment

The terminal crimping device 2 according to the present embodiment, illustrated in FIG. 1 is one for manufacturing a terminal-attached electric wire 1 having a crimped part 13, by crimping a crimping and forming part 12 of the crimp terminal 10 to the part of the electric wire W to form the crimped part 13 (see FIG. 9), as will be described later.

The electric wire W illustrated in FIG. 1 includes a plurality of core wires W1 each made of a metal having an electrically conductive property, such as copper or aluminum (see FIG. 7), and a cover part W2 made of a synthetic resin having an electrically insulating property and covering the core wires W1. On an end of the electric wire W, the cover part W2 is peeled off, allowing parts of the core wires W1 to be externally exposed.

The crimp terminal 10 is made of a metal having an electrically conductive property, such as copper, aluminum, or, a metal alloy thereof, and is plated with tin, chromium, or another metal. The crimp terminal 10 is to be crimped to the part of the electric wire W. To describe in more detail, the crimp terminal 10 is crimped to the parts, which are externally exposed due to that the cover part W2 is peeled off, of the core wires W1. The crimp terminal 10 has a contact part 11 and the crimping and forming part 12.

The contact part 11 lies on a front-direction-X1 side, in the front-rear directions X, of the crimp terminal 10, and is formed into a circular column shape. The contact part 11 is caused to come into contact with a counterpart contact part of a counterpart terminal, electrically coupling the crimp terminal 10 and the counterpart terminal.

The crimping and forming part 12 lies on a rear-direction-X2 side, in the front-rear directions X, of the crimp terminal 10, and is formed into a circular cylindrical shape to have a through hole 12a (see FIG. 7) and a flange part 12b. The through hole 12a extends in the front-rear directions X in the crimping and forming part 12, into which the core wires W1 of the electric wire W are to be inserted. The flange part 12b lies on a front-direction-X1 side of the crimping and forming part 12, and externally projects, in radial directions, from an outer peripheral surface of the crimping and forming part 12.

While the core wires W1, the parts of which are externally exposed, are inserted into the through hole 12a of the crimping and forming part 12, the terminal crimping device 2 then drives drive means described later to cause the upper mold 26 to come close to the lower mold 24. When the lower mold and the upper mold are in proximity to each other, the terminal crimping device 2 then causes a lower contact face 241 and an upper contact face 261 to crimp the crimping and forming part 12 to the part of the electric wire W to form the crimped part 13 on the crimp terminal 10. The terminal-attached electric wire 1 having the crimped part 13 is thus manufactured.

Next, the terminal crimping device 2 for manufacturing the terminal-attached electric wire 1 described above will now be described. The terminal crimping device 2 includes, as illustrated in FIG. 1, a base 21, an electric wire holding part 22, a frame 23, the lower mold (anvil) 24, a movement restriction part 25, the upper mold (crimper) 26, and the non-illustrated drive means.

The base 21 is formed into a block shape, such as a rectangular parallelepiped shape. Furthermore, the base 21 is fixed on a work bench where the terminal crimping device 2 is placed, for example.

The electric wire holding part 22 has a lower electric wire holding part 22a that is fixed to the base 21 and onto which the electric wire W is to be mounted, and an upper electric wire holding part 22b that is configured to be able to come close to and away from the lower electric wire holding part 22a in the upper-lower directions Z, and that is able to hold the electric wire W mounted on the lower electric wire holding part 22a.

The lower electric wire holding part 22a has a groove 22a1 that lies at the center in the width directions Y and that extends in the front-rear directions X, restricting the electric wire W from moving in the width directions Y, when the electric wire W is mounted in the groove 22a1.

The electric wire holding part 22 first causes the upper electric wire holding part 22b to come away, in the upper-lower directions Z, from the lower electric wire holding part 22a. The electric wire W is then mounted on the lower electric wire holding part 22a. After that, the electric wire holding part 22 causes the upper electric wire holding part 22b to come close, in the upper-lower directions Z, to the lower electric wire holding part 22a. The electric wire W is thus sandwiched between the lower electric wire holding part 22a and the upper electric wire holding part 22b. When the electric wire W is sandwiched between the lower electric wire holding part 22a and the upper electric wire holding part 22b, the electric wire holding part 22 restricts the electric wire W from moving in the front-rear directions X, the width directions Y, and the upper-lower directions Z.

The frame 23 is fixed to the base 21. The frame 23 has a frame main body 23a and a frame support part 23b supporting the upper mold 26 to be movable in the upper-lower directions Z relative to the frame main body 23a.

The lower mold 24 is fixed to the base 21. The lower mold 24 as described above has, as illustrated in FIG. 2, a lower mold main body part 240, a lower indent part 240a that projects, in the upper direction (a crimping direction) Z1, from the lower mold main body part 240, and the lower contact face 241 lying on an upper surface, in the upper direction Z1, of the lower indent part 240a. The lower mold main body part 240 is formed into a block shape, such as a rectangular parallelepiped shape, and has an upper surface 240f lying at an upper end in the upper direction Z1. Furthermore, the lower mold main body part 240 has a lower mold recessed part 242 that is recessed in the lower direction (an opposite direction to the crimping direction) Z2 and a lower mold projecting part 243 that projects in the upper direction (the crimping direction) Z1, respectively from both end parts 2420, 2430 of the lower contact face 241 in the width directions Y, when viewed in the front-rear directions X. That is, the lower mold 24 according to the present embodiment has the lower contact face 241, and the lower mold recessed part 242 that is recessed in the lower direction Z2 and the lower mold projecting part 243 that projects in the upper direction Z1, respectively from both end parts 2420, 2430 of the lower contact face 241 in the width directions Y (see FIG. 6). The lower mold 24 is then integrally formed with the lower mold main body part 240, the lower contact face 241, the lower mold recessed part 242, and the lower mold projecting part 243.

In other words, in the lower mold 24, the lower mold recessed part 242 lies adjacent to one of both end parts 2420, 2430 of the lower contact face 241 in the width directions Y, and the lower mold projecting part 243 lies adjacent to another one of both end parts 2420, 2430 of the lower contact face 241 in the width directions Y.

The lower contact face 241 is formed on the upper surface lying at an upper end, in the upper direction Z1, of the lower indent part 240a. On the lower contact face 241 as described above, at least the crimping and forming part 12 of the crimp terminal 10 is to be mounted. On the lower contact face 241, when the crimping and forming part 12 is crimped to the part of the electric wire W, the shape of the lower contact face 241 is transferred to the crimped part 13, forming a lower portion 13a of the crimped part 13 (see FIG. 9). The lower contact face 241 according to the present embodiment is, as illustrated in FIG. 6, formed into a recessed shape that is recessed, in the lower direction Z2, with respect to the upper surface, and has a lower mold center part 241c and a pair of both lower mold side parts 241d, 241e. The lower mold center part 241c lies at the center, in the width directions Y, of the lower mold main body part 240. The pair of both lower mold side parts 241d, 241e respectively lie adjacent to the lower mold center part 241c in the width directions Y, that is, respectively lie adjacent to both sides, in the width directions Y, of the lower mold center part 241c, and are each formed into an arc shape that is recessed in the lower direction Z2.

The lower mold recessed part 242 lies adjacent to one end part, in the width directions Y, of the lower contact face 241, that is, the end part 2420, and is recessed, in the lower direction Z2, from the upper surface 240f. Furthermore, the lower mold recessed part 242 has a lower recessed part first opposed wall 242a and a lower recessed part second opposed wall 242b facing each other in the width directions Y, a lower recessed part third opposed wall 242c and a lower recessed part fourth opposed wall 242d facing each other in the front-rear directions X, and a lower recessed part bottom part 242e.

The lower mold projecting part 243 lies adjacent to another end part, in the width directions Y, of the lower contact face 241, that is, the end part 2430, and projects, in the upper direction Z1, from the upper surface 240f. Furthermore, the lower mold projecting part 243 has a lower projecting part first opposed wall 243a and a lower projecting part second opposed wall 243b facing each other in the width directions Y, a lower projecting part third opposed wall 243c and a lower projecting part fourth opposed wall 243d facing each other in the front-rear directions X, and a lower projecting part tip part 243e.

A length 24L2 of the lower mold recessed part 242 in the front-rear directions X is, as illustrated in FIG. 3, longer than a length 24L1 of the lower indent part 240a in the front-rear directions X. Furthermore, a length 24L3 of the lower mold projecting part 243 in the front-rear directions X is longer than the length 24L1 of the lower indent part 240a in the front-rear directions X.

The movement restriction part 25 lies on a front-direction-X1 side, with respect to the lower mold 24, as illustrated in FIG. 1. Furthermore, the movement restriction part 25 has a movement restriction part main body 25a and a pair of flange receiving parts 25b, 25c.

The movement restriction part main body 25a is formed into a block shape, such as a rectangular parallelepiped shape. The pair of flange receiving parts 25b, 25c project, in the upper direction Z1, from an upper surface of the movement restriction part main body 25a. Furthermore, the pair of flange receiving parts 25b, 25c are disposed and separated from each other at a gap in the width directions Y. The contact part 11 of the crimp terminal 10 is to be inserted into the gap between the flange receiving part 25b and the flange receiving part 25c. While the contact part 11 is inserted into the gap between the pair of flange receiving parts 25b, 25c in the width directions Y, the pair of flange receiving parts 25b, 25c are respectively in contact with the contact part 11 in the width directions Y. The movement restriction part 25 thus restricts the crimp terminal 10 from moving in the width directions Y. In addition, while the crimping and forming part 12 is mounted on the lower contact face 241 of the lower mold 24, the pair of flange receiving parts 25b, 25c are respectively in contact with the flange part 12b of the crimping and forming part 12 in the front-rear directions X. The movement restriction part 25 thus restricts the crimp terminal 10 from moving in the front direction X1.

The upper mold 26 is supported by the frame support part 23b, and faces the lower mold 24 in the upper-lower directions Z. Furthermore, when the frame support part 23b is moved, in the upper-lower directions Z, relative to the frame main body 23a, the upper mold 26 comes close to or away from the lower mold 24 in the upper-lower directions Z. When the upper mold 26 is moved in the lower direction Z2, in the upper-lower directions Z, relative to the lower mold 24 being fixed, the upper mold 26 crimps the crimping and forming part 12 to the part of the electric wire W. That is, for the upper mold 26, a welding direction corresponds to a direction when the upper mold 26 is moved in the lower direction Z2, and an opposite direction corresponds to a direction when the upper mold 26 is moved in the upper direction Z1. On the other hand, when a relative movement is taken into account, a welding direction and an opposite direction for the lower mold 24 are respectively opposite to the welding direction and the opposite direction for the upper mold 26.

The upper mold 26 as described above has, as illustrated in FIG. 4, an upper mold main body part 260, an upper indent part 260a that projects, in the lower direction (the crimping direction) Z2, from the upper mold main body part 260, and the upper contact face 261 lying on a lower surface of the upper indent part 260a. The upper mold main body part 260 is formed into a block shape, such as a rectangular parallelepiped shape, and has a lower surface 260f lying at a lower end in the lower direction Z2. Furthermore, the upper mold main body part 260 has an upper mold recessed part 262 that is recessed in the upper direction (the opposite direction to the crimping direction) Z1 and that engages with the lower mold projecting part 243, when the lower mold and the upper mold are in proximity to each other, and an upper mold projecting part 263 that projects in the lower direction (the crimping direction) Z2 and that engages with the lower mold recessed part 242, when the lower mold and the upper mold are in proximity to each other, respectively from both end parts 2620, 2630 of the upper contact face 261 in the width directions Y, when viewed in the front-rear directions X. That is, the upper mold 26 has the upper contact face 261, and the upper mold recessed part 262 that is recessed in the upper direction Z1 and that engages with the lower mold projecting part 243, when the lower mold and the upper mold are in proximity to each other, and the upper mold projecting part 263 that projects in the lower direction Z2 and that engages with the lower mold recessed part 242, respectively from both end parts 2620, 2630 of the upper contact face 261 in the width directions Y, when viewed in the front-rear directions X. The upper mold 26 is then integrally formed with the upper mold main body part 260, the upper contact face 261, the upper mold recessed part 262, and the upper mold projecting part 263.

In other words, in the upper mold 26, the upper mold recessed part 262 lies adjacent to one of both end parts 2620, 2630 of the upper contact face 261 in the width directions Y, and the upper mold projecting part 263 lies adjacent to another one of both end parts 2620, 2630 of the upper contact face 261 in the width directions Y.

The upper contact face 261 is formed on the lower surface lying at a lower end, in the lower direction Z2, of the upper indent part 260a. Furthermore, the upper contact face 261 faces the lower contact face 241 in the upper-lower directions Z. On the upper contact face 261, when the lower mold and the upper mold are in proximity to each other, described later, and when the crimping and forming part 12 is crimped to the part of the electric wire W, together with the lower contact face 241, the shape of the upper contact face 261 is transferred to the crimped part 13, forming an upper portion 13b of the crimped part 13 (see FIG. 9). The upper contact face 261 according to the present embodiment is, as illustrated in FIG. 6, formed into a recessed shape that is recessed, in the upper direction Z1, with respect to the lower surface, and has an upper mold center part 261c and a pair of both upper mold side parts 261d, 261e. The upper mold center part 261c lies at the center, in the width directions Y, of the upper mold main body part 260. The pair of both upper mold side parts 261d, 261e respectively lie adjacent to the upper mold center part 261c in the width directions Y, that is, respectively lie adjacent to both sides, in the width directions Y, of the upper mold center part 261c, and are each formed into an arc shape that is recessed in the upper direction Z1, with respect to the upper mold center part 261c.

The upper mold recessed part 262 lies adjacent to one end part, in the width directions Y, of the upper contact face 261, that is, the end part 2620, and is recessed, in the upper direction Z1, from the lower surface 260f. Furthermore, the upper mold recessed part 262 has an upper mold recessed part first opposed wall 262a and an upper mold recessed part second opposed wall 262b facing each other in the width directions Y, an upper mold recessed part third opposed wall 262c and an upper mold recessed part fourth opposed wall 262d facing each other in the front-rear directions X, and an upper mold recessed part bottom part 262e.

The upper mold projecting part 263 lies adjacent to another end part, in the width directions Y, of the upper contact face 261, that is, the end part 2630, and projects, in the lower direction Z2, from the lower surface 260f. Furthermore, the upper mold projecting part 263 has an upper mold projecting part first opposed wall 263a and an upper mold projecting part second opposed wall 263b facing each other in the width directions Y, an upper mold projecting part third opposed wall 263c and an upper mold projecting part fourth opposed wall 263d facing each other in the front-rear directions X, and an upper mold tip part 263e.

A length 26L2 of the upper mold recessed part 262 in the front-rear directions X is, as illustrated in FIG. 5, longer than a length 26L1 of the upper indent part 260a in the front-rear directions X. Furthermore, a length 26L3 of the upper mold projecting part 263 in the front-rear directions X is longer than the length 26L1 of the upper indent part 260a in the front-rear directions X.

When the drive means causes the frame support part 23b to move, in the upper-lower directions Z, relative to the frame main body 23a, the upper mold 26 comes close to or away from the lower mold 24 in the upper-lower directions Z.

Next, a method of manufacturing the terminal-attached electric wire 1 will now be described. The operator first inserts the core wires W1 of the electric wire W into the through hole 12a of the crimping and forming part 12 of the crimp terminal 10. Next, as illustrated in FIG. 7, while the core wires W1 are inserted into the through hole 12a, the operator mounts the crimping and forming part 12 of the crimp terminal 10 onto the lower contact face 241 of the lower mold 24 in the terminal crimping device 2, and mounts the electric wire W onto the lower electric wire holding part 22a of the electric wire holding part 22 (see FIG. 1).

Next, the operator causes the upper electric wire holding part 22b to come close, in the upper-lower directions Z, to the lower electric wire holding part 22a, and causes the lower electric wire holding part 22a and the upper electric wire holding part 22b to sandwich the electric wire W.

Next, the operator causes the non-illustrated drive means to drive, causes the upper mold 26 to move in the lower direction Z2, in the upper-lower directions Z, relative to the lower mold 24, and causes the upper mold 26 to come close to the lower mold 24 (hereinafter the expression will be abbreviated to “when the lower mold and the upper mold are in proximity to each other”). As illustrated in FIG. 8, with the lower contact face 241 of the lower mold 24 and the upper contact face 261 of the upper mold 26, the crimping and forming part 12 is then pressed (compressed) in the upper-lower directions Z. To describe more specifically, when the lower mold and the upper mold are in proximity to each other, the crimping and forming part 12 is compressed, in the upper-lower directions Z, and extends in the width directions Y. The shape of the lower contact face 241 and the shape of the upper contact face 261 are transferred to the crimp terminal 10. The crimped part 13 is formed. The crimp terminal 10 and the electric wire W are thus electrically coupled to each other. That is, during the compression, the terminal crimping device 2 crimps the crimping and forming part 12 to the core wires W1 inserted into the through hole 12a of the crimp terminal 10, manufacturing the terminal-attached electric wire 1 where the crimp terminal 10 and the electric wire W are integrally formed.

After that, the operator causes the non-illustrated drive means to drive, causes the upper mold 26 to move in the upper direction Z1, in the upper-lower directions Z, relative to the lower mold 24, and, as illustrated in FIG. 9, causes the upper mold 26 to come away from the lower mold 24. After the crimping, the operator removes the terminal-attached electric wire 1 mounted on the lower electric wire holding part 22a and the lower mold 24.

The terminal crimping device 2 according to the present embodiment has the configuration described below. The terminal crimping device 2 includes the lower mold 24 and the upper mold 26 that are able to come close to and away from each other in the upper-lower directions Z. The lower mold 24 has the lower contact face 241 onto which the crimping and forming part 12 is to be at least mounted, and the lower mold recessed part 242 that is recessed in the opposite direction to the crimping direction and the lower mold projecting part 243 that projects in the crimping direction, respectively from both end parts 2420, 2430 of the lower contact face 241 in the width directions Y. The upper mold 26 has the upper contact face 261 that crimps the crimping and forming part 12 to the part of the electric wire W, together with the lower contact face 241, when the lower mold and the upper mold are in proximity to each other, and the upper mold recessed part 262 that is recessed in the opposite direction to the crimping direction and that engages with the lower mold projecting part 243, when the lower mold and the upper mold are in proximity to each other, and the upper mold projecting part 263 that projects in the crimping direction and that engages with the lower mold recessed part 242, when the lower mold and the upper mold are in proximity to each other, respectively from both end parts 2620, 2630 of the upper contact face 261 in the width directions Y. Therefore, in the terminal crimping device 2 according to the present embodiment, when the lower mold and the upper mold are in proximity to each other, the crimped part 13 sandwiched, in the width directions Y, between the upper mold projecting part 263 and the lower mold projecting part 243 is, when the upper mold 26 comes away from the lower mold 24, in the upper-lower directions Z, released from the state where the crimped part 13 is sandwiched, in the width directions Y, between the upper mold projecting part 263 and the lower mold projecting part 243. As a result, in the terminal crimping device 2 according to the present embodiment, when the upper mold 26 comes away from the lower mold 24, the crimped part 13 is not sandwiched, in the width directions Y, between the upper mold projecting part 263 and the lower mold projecting part 243. Therefore, in the terminal crimping device 2 according to the present embodiment, in a state where, after the upper mold comes away from the lower mold, the crimped part 13 is in contact with the lower contact face 241, there is no opposing part in the width directions Y on one end part, which is opposite to the lower mold projecting part 243, of both end parts of the crimped part 13 in the width directions Y, allowing the crimped part 13 to move in a direction in which the crimped part 13 moves away from the lower mold projecting part 243. Therefore, in the terminal crimping device 2 according to the present embodiment, it is possible to prevent the crimp terminal 10 from sticking to the lower mold 24, allowing the crimp terminal 10 to be easily removed from the molds. In addition, since the terminal crimping device 2 according to the present embodiment has the configuration described above, when the lower mold 24 and the upper mold 26 are in proximity to each other, the lower contact face 241 and the upper contact face 261 both then press the crimping and forming part 12 being sandwiched, in the width directions Y, between the lower mold projecting part 243 and the upper mold projecting part 263, allowing the crimping and forming part 12 to plastically deform to form the crimped part 13. As a result, in the terminal crimping device 2 according to the present embodiment, the lower mold projecting part 243 and the upper mold projecting part 263 are able to restrict the crimping and forming part 12 from extending in the width directions Y and plastically deforming, making it possible to manufacture the terminal-attached electric wire 1 while preventing burrs from occurring on the crimped part 13.

The length 24L3 of the lower mold projecting part 243 in the front-rear directions X illustrated in FIG. 3 is longer than the length 24L1 of the lower indent part 240a in the front-rear directions X. In addition, the length 26L3 of the upper mold projecting part 263 in the front-rear directions X illustrated in FIG. 5 is longer than the length 26L1 of the upper indent part 260a in the front-rear directions X. By therefore extending the lengths, in the front-rear directions X, of the lower mold projecting part 243 and the upper mold projecting part 263 preventing burrs from occurring on the crimped part 13 longer than the lengths, in the front-rear directions X, of the indent parts 240a, 260a, it is further possible to prevent the crimp terminal 10 from sticking to the lower mold 24 and the upper mold 26, allowing the crimp terminal 10 to be further easily removed from the molds.

Note that, in the terminal crimping device 2 according to the embodiment described above, the crimping and forming part 12 of the crimp terminal 10 has a circular cylindrical shape. However, the terminal crimping device 2 according to the present embodiment is not limited to such a configuration. For example, as to the crimp terminal 10 used in the terminal crimping device 2, the crimping and forming part 12 having a rectangular cylindrical shape may be used.

Furthermore, in the terminal crimping device 2 according to the embodiment described above, the electric wire holding part 22 is included. However, in the terminal crimping device 2 according to the present embodiment, the electric wire holding part 22 may not be included. If the terminal crimping device 2 does not include the electric wire holding part 22, it is conceivable that the crimped part 13 comes into contact with the upper contact face 261 of the upper mold 26. However, in the terminal crimping device 2 according to the present embodiment, in a state where, after the upper mold 26 comes away from the lower mold 24, the crimped part 13 is in contact with the upper contact face 261, there is no opposing part in the width directions Y on one end part, which is opposite to the upper mold projecting part 263, of both end parts of the crimped part 13 in the width directions Y, allowing the crimped part 13 to move in a direction in which the crimped part 13 moves away from the upper mold projecting part 263. Therefore, in the terminal crimping device 2 according to the present embodiment, it is possible to prevent the crimp terminal 10 from sticking to one of the upper mold 26 and the lower mold 24, allowing the crimp terminal 10 to be easily removed from the molds.

Furthermore, in the terminal crimping device 2 according to the embodiment described above, the lower contact face 241, to which the shape of the lower portion 13a of the crimped part 13 is transferred, is formed into a recessed shape that is recessed, in the lower direction Z2, with respect to the upper surface 240f, and has the lower mold center part 241c and the pair of both lower mold side parts 241d, 241e. However, the lower contact face 241 according to the present embodiment is not limited to have the shape described above. It is possible to appropriately change the shape in accordance with the shape of the lower portion 13a of the crimped part 13.

Furthermore, in the terminal crimping device 2 according to the embodiment described above, the upper contact face 261, to which the shape of the upper portion 13b of the crimped part 13 is transferred, is formed into a recessed shape that is recessed, in the upper direction Z1, with respect to the lower surface 260f, and has the upper mold center part 261c and the pair of both upper mold side parts 261d, 261e. However, the upper contact face 261 according to the present embodiment is not limited to have the shape described above. It is possible to appropriately change the shape in accordance with the shape of the upper portion 13b of the crimped part 13.

Furthermore, in the terminal crimping device 2 illustrated in the embodiment described above, the lower mold 24 has the lower indent part 240a that projects, in the upper direction Z1, from the lower mold main body part 240, and the upper mold 26 has the upper indent part 260a that projects, in the lower direction Z2, from the upper mold main body part 260. However, the terminal crimping device 2 illustrated in the present embodiment is not limited to such a configuration. The lower mold 24 may not have the lower indent part 240a, and the upper mold 26 may not have the upper indent part 260a.

Furthermore, in the terminal crimping device 2 according to the embodiment described above, the length of the lower mold recessed part 242 in the front-rear directions X is longer than the length of the lower indent part 240a in the front-rear directions X, the length of the lower mold projecting part 243 in the front-rear directions X is longer than the length of the lower indent part 240a in the front-rear directions X, the length of the upper mold recessed part 262 in the front-rear directions X is longer than the length of the upper indent part 260a in the front-rear directions X, and the length of the upper mold projecting part 263 in the front-rear directions X is longer than the length of the upper indent part 260a in the front-rear directions X. However, the terminal crimping device 2 according to the present embodiment is not limited to the configuration described above. It is possible to appropriately change the lengths of the indent parts 240a, 260a in the front-rear directions X, the lengths of the recessed parts 242, 262 in the front-rear directions X, and the lengths of the projecting parts 243, 263 in the front-rear directions X.

The terminal crimping device according to the present embodiment has the configuration described above, allowing a crimp terminal to be easily removed from molds.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal crimping device for manufacturing a terminal-attached electric wire having a crimped part, the terminal crimping device comprising:
a lower mold; and
an upper mold, wherein
the lower mold and the upper mold are able to come close to and away from each other in upper-lower directions,
the terminal crimping device is configured to crimp, when the lower mold and the upper mold are in proximity to each other, a crimping and forming part of a crimp terminal to a part of the electric wire to form the crimped part on the crimp terminal,
the lower mold has:
a lower contact face onto which at least the crimping and forming part is to be mounted, and
a lower mold recessed part that is recessed in an opposite direction to a crimping direction and a lower mold projecting part that projects in the crimping direction, respectively from both end parts of the lower contact face in width directions,
the upper mold has:
an upper contact face that crimps the crimping and forming part to the part of the electric wire, together with the lower contact face, when the lower mold and the upper mold are in proximity to each other, and
an upper mold recessed part that is recessed in the opposite direction to the crimping direction and an upper mold projecting part that projects in the crimping direction, respectively from both end parts of the upper contact face in the width directions, the upper mold recessed part engaging with the lower mold projecting part when the lower mold and the upper mold are in proximity to each other, the upper mold projecting part engaging with the lower mold recessed part when the lower mold and the upper mold are in proximity to each other.

2. The terminal crimping device according to claim 1, wherein,
with respect to the lower mold,
the upper mold recessed part is positioned adjacent to one of the both end parts of the lower contact face in the width directions, and
the upper mold projecting part is positioned adjacent to another one of the both end parts of the lower contact face in the width directions, and,
with respect to the upper mold,
the lower mold recessed part is positioned adjacent to one of the both end parts of the upper contact face in the width directions, and
the lower mold projecting part is positioned adjacent to another one of the both end parts of the upper contact face in the width directions.

3. The terminal crimping device according to claim 1, wherein
the lower mold has:
a lower mold main body part,
a lower indent part that projects from the lower mold main body part in the crimping direction, and
the lower contact face lying on an upper surface of the lower indent part,
a length of the lower mold projecting part in front-rear directions is longer than a length of the lower indent part in the front-rear directions,
the upper mold has:
an upper mold main body part,
an upper indent part that projects from the upper mold main body part in the crimping direction, and
the upper contact face lying on a lower surface of the upper indent part, and
a length of the upper mold projecting part in the front-rear directions is longer than a length of the upper indent part in the front-rear directions.

4. The terminal crimping device according to claim 2, wherein
the lower mold has:
a lower mold main body part,
a lower indent part that projects from the lower mold main body part in the crimping direction, and
the lower contact face lying on an upper surface of the lower indent part,
a length of the lower mold projecting part in front-rear directions is longer than a length of the lower indent part in the front-rear directions,
the upper mold has:
an upper mold main body part,
an upper indent part that projects from the upper mold main body part in the crimping direction, and
the upper contact face lying on a lower surface of the upper indent part, and
a length of the upper mold projecting part in the front-rear directions is longer than a length of the upper indent part in the front-rear directions.
